(19) United States
(12) Patent Application Publication
(10) Pub. No.: US 2026/0211297 A1
(43) Pub. Date: Jul. 23, 2026

(54) CAMERA MODULE AND ELECTROIC DEVICE HAVING THE SAME

(71) Applicant: Rayprus Technology (Foshan) Co., Ltd., Foshan (CN)

(72) Inventors: JING-WEI LI, Shenzhen (CN); SHENG-JIE DING, Jincheng (CN); JIA-QI WU, Jincheng (CN); ZHU-CHENG HAN, Jincheng (CN); MAN CHEN, Jincheng (CN)

(21) Appl. No.: 19/176,505

(22) Filed: Apr. 11, 2025

(30) Foreign Application Priority Data
Jan. 22, 2025 (CN) 202510103994.8

(51) Int. Cl. G03B 13/34; G03B 30/00; H01F 7/08

(52) U.S. Cl. CPC G03B 13/34; G03B 30/00; H01F 7/081

(57) ABSTRACT

A camera module includes an image sensing assembly comprising an image sensor, a lens assembly comprising a plurality of lenses, a focusing assembly comprising a first driving element configured to drive the lens assembly along a first direction so that each of the plurality of lenses is focused onto the image sensor, and a switching assembly comprising a second driving element configured to drive the lens assembly along a second direction so that different ones of the plurality of lenses image onto the image sensor. The first direction is different from the second direction.

### FIELD

The subject matter herein generally relates to the field of imaging devices, and in particular, to a camera module and an electronic device.

### BACKGROUND

Multi-camera systems include various types of lenses such as telephoto, main, and wide-angle lenses. Each lens is equipped with an image sensor and a driver. When the system needs to use a particular lens, the system individually activates the image sensor corresponding to the particular lens.

However, such activating method not only increases the overall system cost, but also increases the structural complexity of the system.

### BRIEF DESCRIPTION OF THE DRAWINGS

Implementations of the present technology will now be described, by way of example only, with reference to the attached figures.

FIG. 1 is a diagrammatic view of a camera module according to an embodiment of the present application.

FIG. 2 is a cross-sectional view of the camera module in FIG. 1, taken along line II-II.

FIG. 3 is another cross-sectional view of the camera module in FIG. 1, taken along line III-III.

FIG. 4 is an exploded view of the camera module in FIG. 1.

FIG. 5 is similar to FIG. 4, but view from a different angle.

FIG. 6 is an exploded view of an image sensing assembly of the camera module in FIG. 1.

FIG. 7 is a diagrammatic view showing a force exerted on a first coil in a first magnetic field when a clockwise current is applied on the first coil of the camera module in FIG. 1.

FIG. 8 is a diagrammatic view showing a force exerted on the first coil in the first magnetic field when a counterclockwise current is applied on the first coil of the camera module in FIG. 1.

FIG. 9 is a diagrammatic view showing a force exerted on a second coil in a second magnetic field when a clockwise current is applied on the second coil of the camera module in FIG. 1.

FIG. 10 is a diagrammatic view showing a force exerted on the second coil in the second magnetic field when a counterclockwise current is applied on the second coil of the camera module in FIG. 1.

FIG. 11 is a diagrammatic view of an electronic device according to one embodiment of the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

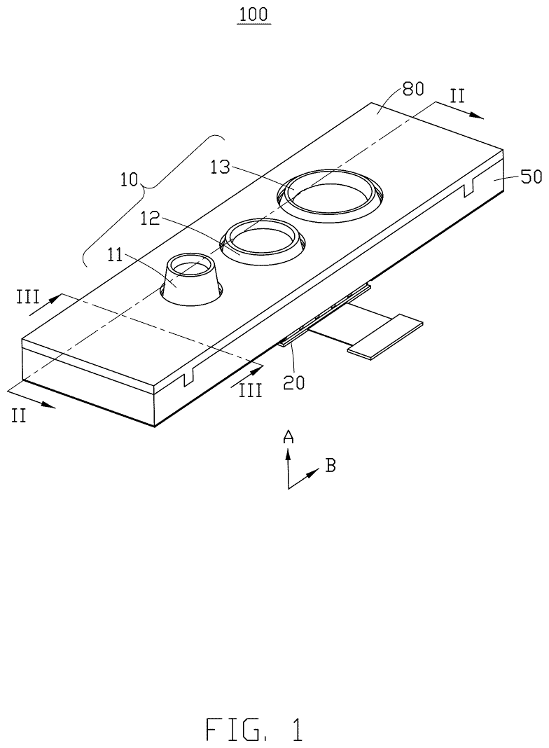

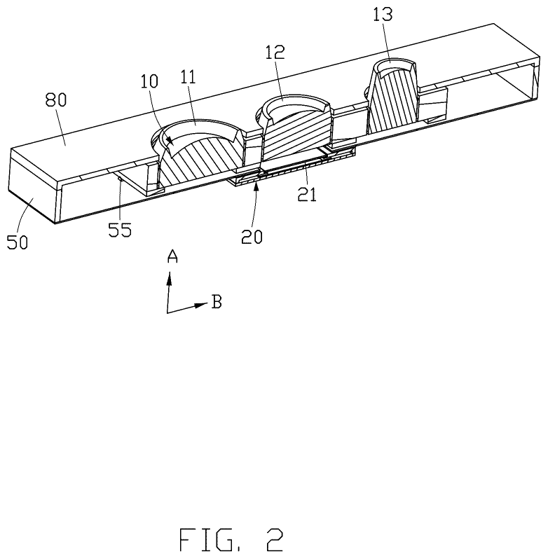

Referring to FIGS. 1 and 2, a camera module 100 is provided according to an embodiment of the present application, the camera module 100 includes a lens assembly 10, an image sensing assembly 20, a focusing assembly 30, and a switching assembly 40. The lens assembly 10 is positioned such that light passing through the lens assembly 10 is directed toward the image sensing assembly 20. The focusing assembly 30 is connected to the lens assembly 10 and configured to adjust the position of the lens assembly 10 relative to the image sensing assembly 20 along a first direction, thereby realizing accurate focusing. The switching assembly 40 is also connected to the lens assembly 10 and configured to move the lens assembly 10 along a second direction different from the first direction, thereby switching different lenses of the lens assembly 10 to correspond to the image sensing assembly 20.

The lens assembly 10 includes multiple lenses, which may have different focal lengths, fields of view, or optical characteristics to achieve various imaging functions. In this embodiment, the multiple lenses include a main camera lens 11, a telephoto lens 12, and a wide-angle lens 13.

The image sensing assembly 20 includes a single image sensor 21 for receiving light signals passing through the lens assembly 10 and converting the light signals into electrical signals. The electrical signals can be used to form images. The image sensor 21 may be a Charge-Coupled Device (CCD) or a Complementary Metal-Oxide-Semiconductor (CMOS) image sensor.

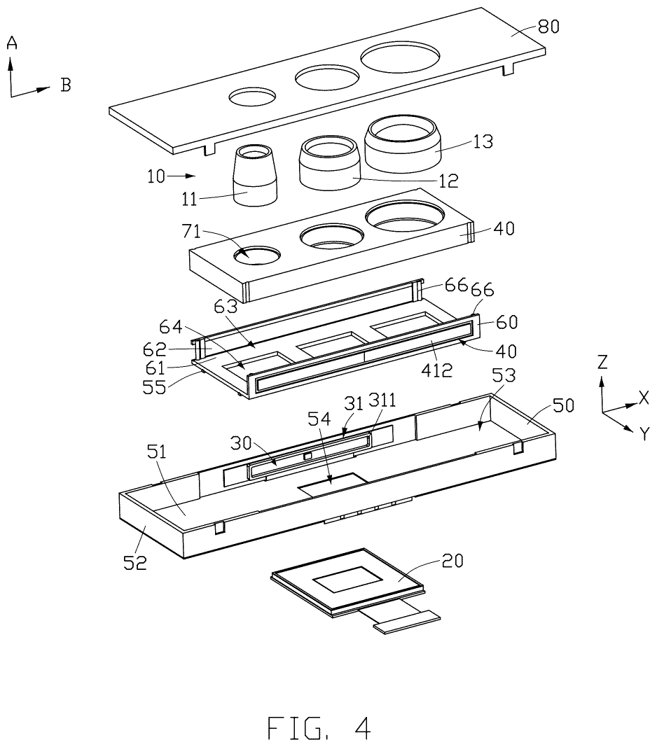

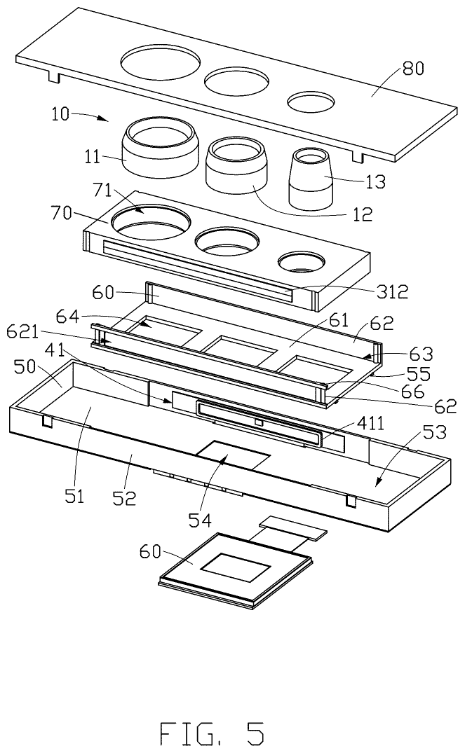

Referring also to FIGS. 4 and 5, the focusing assembly 30 includes a first driving element 31. The first driving element 31 is used to drive the multiple lenses to move along the first direction A. The first driving element 31 includes a first coil 311 and a first magnetic component 312. The first magnetic component 312 interacts electromagnetically with the first coil 311 when the first coil 311 is energized. Through the attractive or repulsive electromagnetic force, the multiple lenses are driven to move. In some embodiments, the first driving element 31 may be a Voice Coil Motor (VCM), a Piezoelectric Ceramic Actuator, or a Shape Memory Alloy Actuator.

When the first driving element 31 is working, by precisely adjusting the magnitude and direction of the current in the first coil 311, the first magnetic component 312 finely moves the multiple lenses along the first direction A. Thus, the relative distance between the lenses and the image sensor 21 is adjusted so that each lens can be focused on the image sensor 21. Thus, different lenses can accurately focus the light signals onto the image sensor 21 under different scenarios, thereby producing clear images.

The switching assembly 40 includes a second driving element 41. The second driving element 41 is used to drive the multiple lenses along the second direction B. The second direction B is different from the first direction A. The second driving element 41 may use an electromagnetic driving structure similar as that of the first driving element 31. The second driving element 41 including a second coil 411 and a second magnetic component 412. In some embodiments, the second driving element 41 can be a Voice Coil Motor, a Piezoelectric Ceramic Actuator, or a Shape Memory Alloy Actuator.

When the second coil 411 is energized, the magnetic field generates by the second coil 411 interacts with the second magnetic component 412, thereby producing electromagnetic force that drives the lenses to move along the second direction B. Thus, different lenses may form images on the image sensor 21 so that users can switch between different lenses as needed when using the camera module 100. The users can select the different lenses to meet various shooting requirements, for example, to meet requirements of different focal lengths, shooting scenarios, or lighting conditions. The desired lens is moved into the appropriate position corresponding to the image sensor 21 to form images, thus ensuring that the camera module 100 can provide a diverse range of imaging effects.

In this application, the focusing assembly 30 and the switching assembly 40 work in coordination so that different lenses can share a single image sensor 21, eliminating the need for equipping each lens with a respective image sensor and a respective driver. Thus, the present application reduces the number of image sensors in the camera module 100, thereby lowering hardware costs. Furthermore, the maintenance cost is also reduced.

Regarding hardware layout, the existing multi-camera system has multiple lenses, while each lens is equipped with a respective image sensor and a respective driver, which may occupy a large space in the camera system. The present application reduces a large number of hardware components, thereby enabling a more rational layout within a limited space, and a simplified wiring structure reduces the risk of wiring failures and improves hardware reliability.

Regarding to, the existing camera system requires complex code for each lens. However, the present application only needs to control the single image sensor 21 and its corresponding components to operate. There is no need for multiple complex interactive programs, thus reducing software development difficulty, increasing efficiency, reducing software errors and compatibility issues, and enhancing overall system stability and maintainability.

Referring to FIGS. 4 and 5, in this embodiment, the camera module 100 further includes a base 50, a first movable seat 60, and a second movable seat 70. The second movable seat 70 is movably disposed on the first movable seat 60 along the first direction A, and the first movable seat 60 is movably disposed on the base 50 along the second direction B. The lens assembly 10 is arranged on the second movable seat 70.

The base 50 is generally box-shaped, and has a length direction X, a width direction Y, and a thickness direction Z. The thickness direction Z is parallel to the first direction A. The length direction X is parallel to the second direction. The base 50 includes a substrate 51 and multiple side plates 52. These side plates 52 enclose one side of the substrate 51 to form a receiving space 53. The first movable seat 60 and the second movable seat 70 are both housed in the receiving space 53. The first coil 311 is provided on the side of one side plate 52 facing the receiving space 53, and the second coil 411 is provided on the side of another side plate 52 facing the receiving space 53. Along the width direction Y, the first coil 311 and the second coil 411 are generally positioned opposite each other.

The first movable seat 60 is substantially U-shaped. The first movable seat 60 includes a bottom plate 61 and two side plates 62. The two side plates 62 are spaced apart on one side of the bottom plate 61, forming a holding space 63. The second movable seat 70 is housed within the holding space 63. The second magnetic component 412 is disposed on the side of one side plate 62 facing away from the holding space 63. The first magnetic component 312 is disposed on a side of the second movable seat 70. Along the width direction Y, the side plate 62 corresponding to the first magnetic component 312 is formed with an opening 621 that penetrates through, to reduce obstruction of the magnetic field of the first magnetic component 312.

In this embodiment, the first magnetic component 312 is a neodymium-iron-boron permanent magnet. The first magnetic component 312 has a first magnetic field that is uniform along the first direction A. The first magnetic field is uniformly distributed over the length direction of the base 50. Half of the first magnetic field extends generally perpendicular into the plane of the figure (shown symbolically as “x” in the drawings, similarly below), and the other half of the first magnetic field extends generally perpendicular to the plane of the figure (shown symbolically as “⋅,” similarly below).

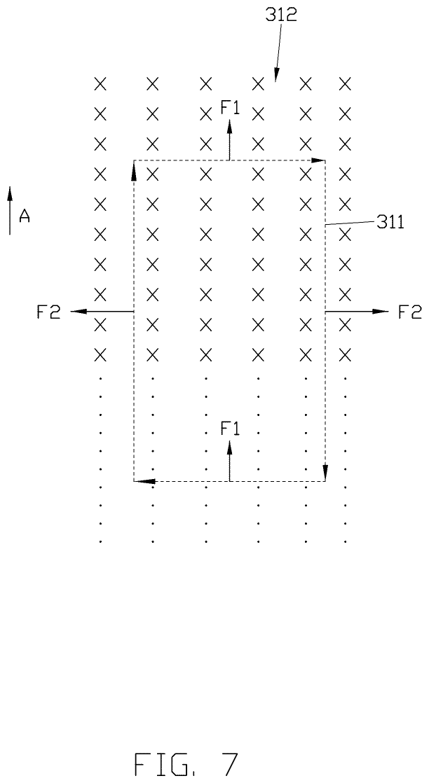

Referring to FIG. 7, in this embodiment, when a clockwise current is introduced into the first coil 311, according to the Fleming's left-hand rule, along the first direction A, the opposite sides of the first coil 311 experience an upward Lorentz force F1. Along the second direction B, the opposite sides of the first coil 311 experience equal and opposite Lorentz forces F2, and the opposite Lorentz forces F2 cancel each other out. Meanwhile, the first magnetic component 312 experiences the reaction force of F1. Because forces act mutually, the first magnetic component 312 is pushed downwards, which in turn drives the lens assembly 10 on the second movable seat 70 to move along the first direction A, thereby switching the different lenses in that direction (e.g., for focusing).

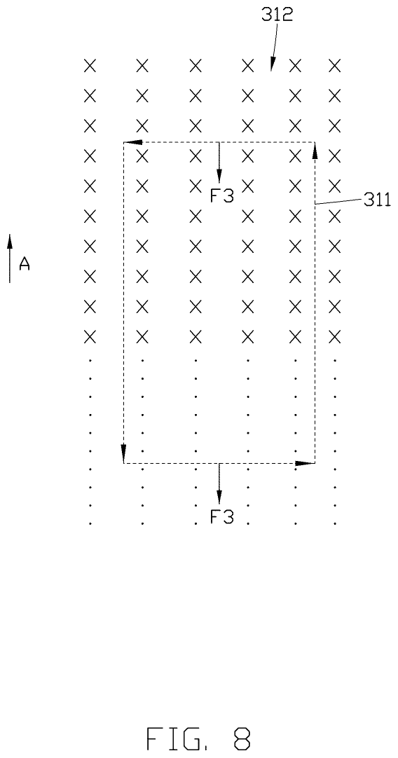

Conversely, referring to FIG. 8, when a counterclockwise current is introduced into the first coil 311, according to the Fleming's left-hand rule, along the first direction A, the opposite sides of the first coil 311 experience a downward Lorentz force F3. In this situation, the first magnetic component 312 experiences the reaction force of F3 in the opposite direction to the previous case, thus pushing the first magnetic component 312 upwards, and consequently moving the lens assembly 10 along the first direction A in the opposite direction.

In this embodiment, the second magnetic component 412 is also a neodymium-iron-boron permanent magnet and has a second magnetic field that is substantially uniform along the second direction B (i.e., length direction X). The second magnetic field is uniformly distributed over the length of the base 50. Half of the second magnetic field extends generally perpendicular into the plane of the figure, and the other half of the second magnetic field extends generally perpendicular to the plane of the figure.

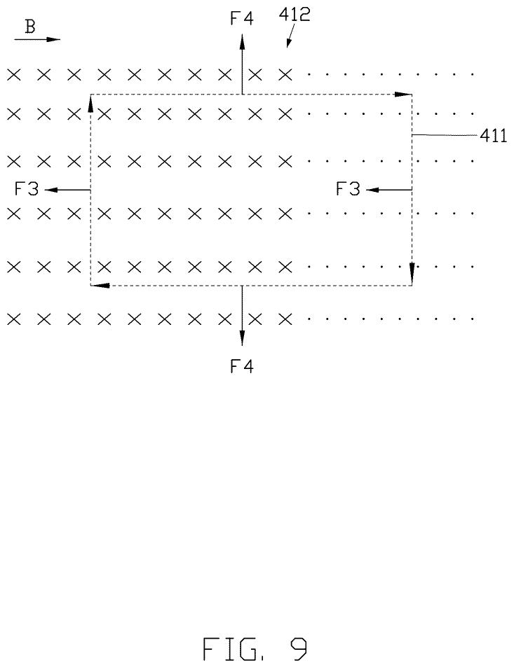

Referring to FIG. 9, when a clockwise current is introduced into the second coil 411, by the Fleming's left-hand rule, along the second direction B, the opposite sides of the second coil 411 experience a leftward Lorentz force F3. Along the second direction B, the opposite sides of the coil experience another pair of Lorentz forces F4 that are equal in magnitude and opposite to each other in direction, and the pair of Lorentz forces F4 cancels each other out. Meanwhile, the second magnetic component 412 experiences the reaction force of F3 which pushes the second magnetic component 412 to the right, thereby driving the lens assembly 10 on the second movable seat 70 to move in the opposite direction along the second direction B, thereby moving the lenses in that direction (e.g., to switch among different lenses).

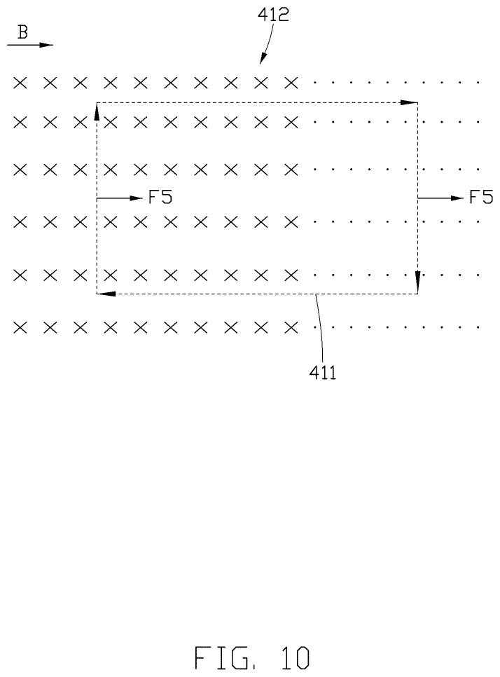

Referring to FIG. 10, when a counterclockwise current is introduced into the second coil 411, according to the Fleming's left-hand rule, along the second direction B, the opposite sides of the second coil 411 experience a rightward Lorentz force F5. At this time, the second magnetic component 412 experiences the reaction force of F5, F5 is opposite in direction to when the current is clockwise, thereby pushing the second magnetic component 412 to the left. Consequently, the lens assembly 10 on the second movable seat 70 moves along the second direction B.

Referring to FIGS. 4 and 5, in this embodiment, the first movable seat 60 has multiple first through-holes 64. The second movable seat 70 has multiple second through-holes 71. The base 50 has a third through-hole 54. Along the first direction A, the image sensor 21 is aligned with the third through-hole 54. Along the second direction B, the multiple first through-holes 64 and the multiple second through-holes 71 correspond one-to-one, and each second through-hole 71 has one lens therein. When the second movable seat 70 moves along the second direction B, the lens set in any second through-hole 71 can switch positions as needed. Different lenses can be aligned with the third through-hole 54 and the image sensor 21 along the second direction B, thereby switching among lenses of different characteristics for imaging. For example, the users can switch from a wide-angle lens 13 to a telephoto lens 12 or vice versa to meet a variety of shooting scenario demands.

Meanwhile, as the first movable seat 60 moves along the first direction A, the multiple first through-holes 64 and the second through-holes 71 move together to drive the lenses along the first direction A, thereby changing the distance between the lenses and the image sensor 21 for accurate focusing on objects at different distances. This structural design ensures that the lens assembly 10 can be adjusted in two different directions. In combination with the driving actions of the first driving element 31 and the second driving element 41 on the first movable seat 60 and the second movable seat 70, the lenses can be positioned in multiple dimensions, enhancing the versatility and flexibility of the entire camera module 100.

In this embodiment, a first guide rail 55 is provided on the side of the base 50 facing the first movable seat 60. The first movable seat 60 is provided with a first sliding slot matching the first guide rail 55, which extends along the first direction A. The cooperation between the first guide rail 55 and the first sliding slot provides precise guidance and stable support for the movement of the first movable seat 60 in the first direction A. When the first driving element 31 drives the first movable seat 60, the first movable seat 60 slides along the first guide rail 55, reducing the shaking of the first movable seat 60 during movement, thereby ensuring accuracy and reliability of the movement along the first direction A. This is helpful for precisely controlling the position adjustment of the lens assembly 10 along the first direction A, thereby ensuring that the lens moves along a precise path relative to the image sensor 21 for accurate focusing. It also improves stability and controllability of lens motion along the first direction A. Additionally, this structure reduces friction and collisions with other components during motion, lowering wear-related failure risks and prolonging the service life of the camera module 100, while improving the overall performance and reliability of the system.

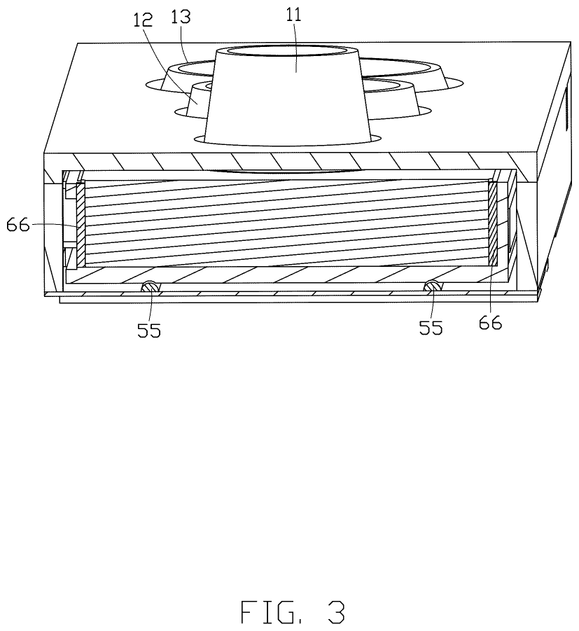

Referring to FIGS. 2 and 3, in this embodiment, a second guide rail 66 is provided on the side of the first movable seat 60 facing the second movable seat 70. The second movable seat 70 has a second sliding slot matching the second guide rail 66, which extends along the second direction B. The cooperation between the second guiding rail 66 and the second sliding slot provides reliable guidance and stable support for the movement of the second movable seat 70 along the second direction B. When driven by the second driving element 41, the second movable seat 70 slides smoothly along the second guide rail 66, preventing shaking of the second guide rail 66, during the movement, thereby ensuring accuracy and stability during the movement in the second direction B. Thus, each lens can accurately align with the image sensor 21. This meets the requirement of switching lenses for different shooting scenarios, for example, the requirement of switching from the telephoto lens 12 to the wide-angle lens 13.

Moreover, the cooperation of the second guide rail 66 and the second sliding slot can reduce frictional resistance during movement, minimize component wear, and extend component service life. This structure also optimizes the mechanical performance of the camera module 100, reduces vibration and noise during operation, and enhances the user experience. From the manufacturing standpoint, it facilitates assembly, improving precision and ensuring product consistency. During maintenance or repair, it facilitates the operations of the second movable seat 70, thus reducing maintenance costs and complexity and further improving overall performance and reliability.

In this embodiment, the camera module 100 further includes a cover 80 that covers the base 50 to enclose the receiving space 53. The lens assembly 10, the focusing assembly 30, and the switching assembly 40 are housed in the receiving space 53. The cover 80 plays several important roles:
The cover 80 protects internal components by preventing dust, moisture, and debris from entering and causing damages to the lens assembly 10, the focusing assembly 30, and the switching assembly 40.
The cover 80 further provides physical protection against external impacts or pressure, safeguarding especially the stability of the focusing assembly 30 and the switching assembly 40.
The cover 80 further reduces g external electromagnetic interference and enhancing electromagnetic compatibility to ensure stable operation of internal electronic components; and improves the aesthetic appearance of the camera module 100, and enhances the overall sense of quality and user experience.

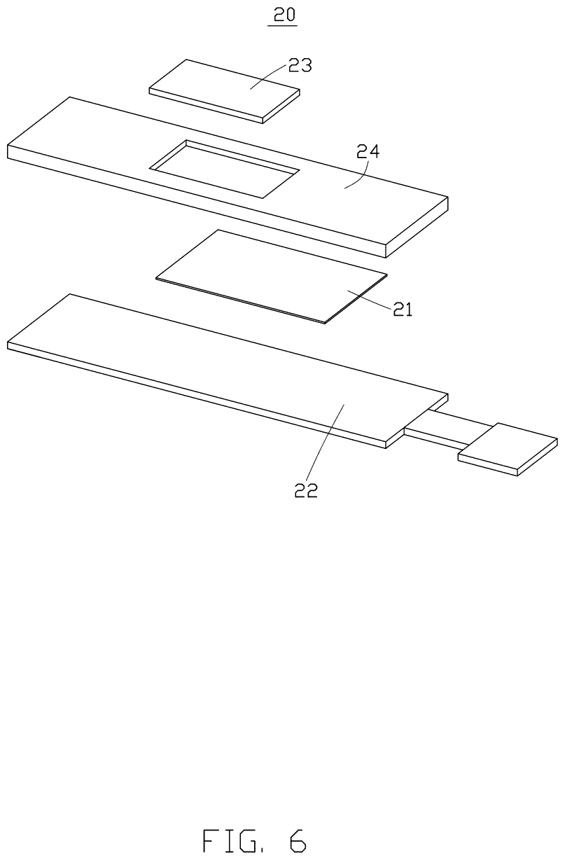

Referring to FIG. 6, in this embodiment, the image sensing assembly 20 further includes a circuit board 22, a filter 23, and a holder 24. The image sensor 21 is disposed on the circuit board 22. The filter 23 is mounted on the holder 24, which is positioned on the side of the base 50 opposite the receiving space 53. One side of the filter 23 is aligned with the third through-hole 54; the other side faces the image sensor 21. Both the first driving element 31 and the second driving element 41 are electrically connected to the circuit board 22. The circuit board 22 provides electrical connections and signal transmission for the image sensor 21, enabling the sensor to convert the captured optical signals into electrical signals and send them via the circuit board 22 to subsequent processing units for further image processing and display.

The filter 23 blocks unwanted wavelengths, only allowing light with certain wavelengths to pass through, thereby improving image quality and color accuracy. For example, the filter 23 may block infrared or ultraviolet light, allowing only visible light to pass through, thereby reducing the interference of non-visible light on image quality, making the images clearer and more lifelike.

Because the first driving element 31 and the second driving element 41 are electrically connected to the circuit board 22, the first driving element 31 and the second driving element 41 can receive control signals from external sources through the circuit board 22. The circuit board 22 can control the operational states of the first and second driving elements 31, 41 (such as current magnitude and direction), thus controlling the movement of the lens assembly 10 along the first direction A and second direction B for focusing and lens-switching. The integration of the driving elements with the image sensor 21 and the filter 23 increases the integration degree and system controllability of the camera module 100, while simplifying overall system design and maintenance. During production, the first driving element 31 and the second driving element 41 also facilitate electrical performance testing and debugging of the entire camera module 100 to ensure proper collaboration among all components. Additionally, the first driving element 31 and the second driving element 41 helps optimize system power consumption and supports stable functioning in various application scenarios (e.g., smartphone photography or security surveillance).

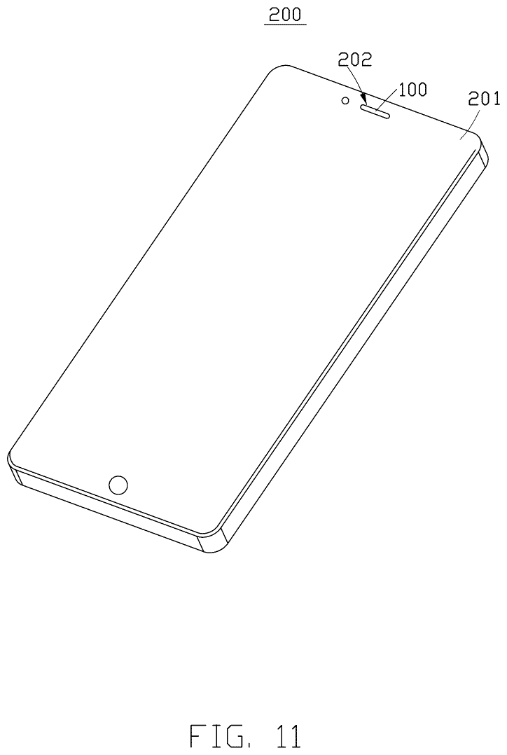

Referring to FIG. 11, an embodiment of the present application further provides an electronic device 200 that includes a housing 201 and the camera module 100 connected to the housing 201. The housing 201 has an opening 202 from which the camera module 100 is exposed. The electronic device 200 may be a mobile phone, a tablet computer, a laptop, a digital camera, a surveillance camera, or any other device requiring imaging capabilities.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A camera module, comprising:
an image sensing assembly comprising an image sensor;
a lens assembly comprising a plurality of lenses;
a focusing assembly comprising a first driving element, and
a switching assembly comprising a second driving element,
wherein the first driving element is configured to drive the lens assembly to move along a first direction so that a corresponding lens of the plurality of lenses corresponding to the image sensor is focused onto the image sensor, the second driving element is configured to drive the lens assembly to move along a second direction so that other lenses of the plurality of lenses image are positioned to correspond to the image sensor, and the first direction is different from the second direction.

2. The camera module of claim 1, further comprising a base, a first movable seat, and a second movable seat, wherein the second movable seat is movably disposed on the first movable seat along the first direction, the first movable seat is movably disposed on the base along the second direction, and the lens assembly is disposed on the second movable seat.

3. The camera module of claim 2, wherein the first movable seat defines a plurality of first through-holes, the second movable seat defines a plurality of second through-holes, the base defines a third through-hole, the image sensor is aligned with the third through-hole along the first direction, the plurality of first through-holes and the plurality of second through-holes correspond to each other one-to-one along the second direction, and the plurality of lenses is correspondingly placed in the plurality of second through-holes.

4. The camera module of claim 2, wherein the first driving element comprises a first coil and a first magnetic component, the first coil is connected to the base, the first magnetic component is connected to the second movable seat, the first magnetic component is configured to interact electromagnetically with the first coil when the first coil is energized.

5. The camera module of claim 4, wherein the first movable seat defines an opening, one side of the opening faces the first magnetic component, and another side of the opening faces the first coil.

6. The camera module of claim 2, wherein the second driving element comprises a second coil and a second magnetic component, the second coil is connected to the base, the second magnetic component is connected to the first movable seat, the second magnetic component is configured to interact electromagnetically with the second coil when the second coil is energized.

7. The camera module of claim 2, wherein the base comprises a first guide rail on a side facing the first movable seat, the first movable seat defines a first sliding slot engaged with the first guide rail, and the first guide rail extends along the first direction.

8. The camera module of claim 2, wherein the first movable seat comprises a second guide rail on a side facing the second movable seat, the second movable seat defines a second sliding slot engaged with the second guide rail, and the second guide rail extends along the second direction.

9. The camera module of claim 2, further comprising a cover, wherein the cover covers the base to define a receiving space, and the lens assembly, the focusing assembly, and the switching assembly are disposed within the receiving space.

10. The camera module of claim 1, wherein the image sensing assembly further comprises a circuit board and a filter, the image sensor is disposed on the circuit board, the filter corresponds to the image sensor, the first driving element and second driving element are electrically connected to the circuit board.

11. An electronic device, comprising:
a housing having an opening; and
a camera module connected to the housing and exposed through the opening, the camera module comprising:
an image sensing assembly comprising an image sensor;
a lens assembly comprising a plurality of lenses;
a focusing assembly comprising a first driving element, and
a switching assembly comprising a second driving element;
wherein the first driving element is configured to drive the lens assembly to move along a first direction so that a corresponding lens of the plurality of lenses corresponding to the image sensor is focused onto the image sensor, the second driving element is configured to drive the lens assembly to move along a second direction so that other lenses of the plurality of lenses image are positioned to correspond to the image sensor, and the first direction is different from the second direction.

12. The electronic device of claim 11, further comprising a base, a first movable seat, and a second movable seat, wherein the second movable seat is movably disposed on the first movable seat along the first direction, the first movable seat is movably disposed on the base along the second direction, and the lens assembly is disposed on the second movable seat.

13. The electronic device of claim 12, wherein the first movable seat defines a plurality of first through-holes, the second movable seat defines a plurality of second through-holes, the base defines a third through-hole, the image sensor is aligned with the third through-hole along the first direction, the plurality of first through-holes and the plurality of second through-holes correspond to each other one-to-one along the second direction, and the plurality of lenses is correspondingly placed in the plurality of second through-holes.

14. The electronic device of claim 12, wherein the first driving element comprises a first coil and a first magnetic component, the first coil is connected to the base, the first magnetic component is connected to the second movable seat, the first magnetic component is configured to interact electromagnetically with the first coil when the first coil is energized.

15. The electronic device of claim 14, wherein the first movable seat defines an opening, one side of the opening faces the first magnetic component, and another side of the opening faces the first coil.

16. The electronic device of claim 12, wherein the second driving element comprises a second coil and a second magnetic component, the second coil is connected to the base, the second magnetic component is connected to the first movable seat, the second magnetic component is configured to interact electromagnetically with the second coil when the second coil is energized.

17. The electronic device of claim 12, wherein the base comprises a first guide rail on a side facing the first movable seat, the first movable seat defines a first sliding slot engaged with the first guide rail, and the first guide rail extends along the first direction.

18. The electronic device of claim 12, wherein the first movable seat comprises a second guide rail on a side facing the second movable seat, the second movable seat defines a second sliding slot engaged with the second guide rail, and the second guide rail extends along the second direction.

19. The electronic device of claim 12, further comprising a cover, wherein the cover covers the base to define a receiving space, and the lens assembly, the focusing assembly, and the switching assembly are disposed within the receiving space.

20. The electronic device of claim 11, wherein the image sensing assembly further comprises a circuit board and a filter, the image sensor is disposed on the circuit board, the filter corresponds to the image sensor, the first driving element and second driving element are electrically connected to the circuit board.
